(19) United States
(12) Patent Application Publication
(10) Pub. No.: US 2008/0053207 A1
(43) Pub. Date: Mar. 6, 2008

(54) CONTROL OF TRANSMISSION POWER IN A COMMUNICATION DEVICE

(75) Inventors: John M. Burgan, North Palm Beach, FL (US); Roberto Gautier, Davie, FL (US); Jose E. Korneluk, Lake Worth, FL (US); Jason T. Young, Palm City, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/467,949

(22) Filed: Aug. 29, 2006

(51) Int. Cl. G01M 15/00

(52) U.S. Cl. 73/116

(57) ABSTRACT

A method for limiting transmission power of a communication device (600). The method can include determining a desired maximum transmission power and determining a plurality of power contribution factors. Each of the power contribution factors can be associated with a respective service active on the communication device. The method also can include determining an expected transmission power based on, at least in part, a sum of the power contribution factors. Further, in response to the expected transmission power exceeding the desired maximum transmission power, the power contribution for at least one of the services active on the communication device can be selectively reduced or terminated. Selectively reducing the power contribution can include reducing a bit rate of a service data stream for the service and/or reducing a duty cycle of a service data stream for the service. Selectively terminating the power contribution can include terminating the service.

### BACKGROUND OF THE INVENTION

1. Field of the Invention

The present invention generally relates to mobile communications and, more particularly, to mobile communication devices.

2. Background of the Invention

The use of mobile stations has grown to an extent that such devices are now ubiquitous throughout most of the industrialized world. Just as their use has grown, so too has the functionality of mobile stations. Indeed, mobile stations now can be used not only for voice communications, but also to perform a number of other tasks. For example, mobile stations can be used to take photographs, capture and stream video, browse the Internet, play games, and send and receive instant messages and e-mail. Moreover, mobile stations can simultaneously perform a plurality of such functions. For example, while a user is engaged in a telephone conversation on a mobile station, the user also can send and receive data in multiple formats. For instance, the user can browse the Internet, communicate data files and communicate via e-mail.

Unfortunately, to maintain a telephone call while simultaneously communicating data can be extremely taxing on a mobile station's transceiver due to increased data transmission rates and longer duty cycles that are required of the transceiver. The increased data transmission rates and longer duty cycles generally result in generation of a significant amount of thermal energy (i.e. heat) by the transceiver and rapid depletion of battery resources.

### SUMMARY OF THE INVENTION

The present invention relates to a method for limiting transmission power of a communication device. The method can include determining a desired maximum transmission power and determining a plurality of power contribution factors. Each of the power contribution factors can be associated with a respective service active on the communication device. The method also can include determining an expected transmission power based on, at least in part, a sum of the power contribution factors. Further, in response to the expected transmission power exceeding the desired maximum transmission power, the power contribution for at least one of the services active on the communication device can be selectively reduced or terminated.

Selectively reducing the power contribution can include reducing a bit rate of a service data stream for the service. In another arrangement, selectively reducing the power contribution can include reducing a duty cycle of a service data stream for the service. In yet another arrangement, selectively terminating the power contribution can include terminating the service.

The method further can include prioritizing each of the services active on the communication device. In such an arrangement, selectively reducing the power contribution can include reducing the power contribution for at least one of the services having a low priority. In one aspect of the invention, prioritizing the services can include determining a quality of service class associated with each of the services.

Determining the power contribution factor can include, for each of the active services, multiplying a bit rate of the service data stream by the energy per bit of the service data stream. The method also can include receiving a request for an increase in instantaneous transmit power of the service data stream for at least a first of the active services, reducing the bit rate of the service data stream for at least one of the active services, and increasing the energy per bit of the service data stream for the first active service.

In another aspect of the invention, the method can include deactivating at least one of the services active on the communication device in response to detecting an actual transmission power exceeding the desired maximum transmission power. In yet another aspect of the invention, the method can include determining an external power contribution factor for at least one external device. Determining the expected transmission power can be based, at least in part, on the external power contribution factor.

The present invention also relates to a communication device that includes a transceiver and a controller. The controller can determine a desired maximum transmission power and determine a plurality of power contribution factors, each of the power contribution factors associated with a respective service active on the communication device. The controller also can determine an expected transmission power based on, at least in part, a sum of the power contribution factors, and selectively reduce or terminate the power contribution for at least one of the services active on the communication device in response to the expected transmission power exceeding the desired maximum transmission power.

The controller can selectively reduce the power contribution by signaling the transceiver to reduce a bit rate of a service data stream for the at least one service and/or by signaling the transceiver to reduce a duty cycle of a service data stream for the service. The controller can selectively terminate the power contribution by terminating the service.

The controller can prioritize each of the services active on the communication device and selectively reduce the power contribution by reducing the power contribution for at least one of the services having a low priority. The controller can prioritize the services by determining a quality of service class associated with each of the services.

The controller also can determine the power contribution factor, for each of the active services, by multiplying a bit rate of the service data stream by the energy per bit of the service data stream. In such an arrangement, the controller can receive a request for an increase in instantaneous transmit power of the service data stream for at least a first of the active services. The controller can signal the transceiver to reduce the bit rate of the service data stream for at least one of the active services, and the controller can signal the transceiver to increase the energy per bit of the service data stream for the first active service.

The controller can deactivate at least one of the services active on the communication device in response to detecting an actual transmission power exceeding the desired maximum transmission power.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 is a flowchart that is useful for understanding the present invention;

FIG. 2 is another flowchart that is useful for understanding the present invention;

FIG. 3 is another flowchart that is useful for understanding the present invention;

FIG. 4 is yet another flowchart that is useful for understanding the present invention;

FIG. 5 depicts a protocol stack having a plurality of protocol layers that are useful for understanding the present invention; and

FIG. 6 depicts a block diagram of a communication device that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for reducing the transmission power of communication device, thereby reducing heat generation and instantaneous current draw from the communication device's battery, and reducing the total amount of RF energy generated by the communication device. The transmission power can be reduced by prioritizing services active on the communication device, and reducing or terminating the power contribution of lower priority services. Accordingly, high priority services can remain unaffected by the reduction in transmission power. The active services can be prioritized based on, for example, their respective quality of service classes.

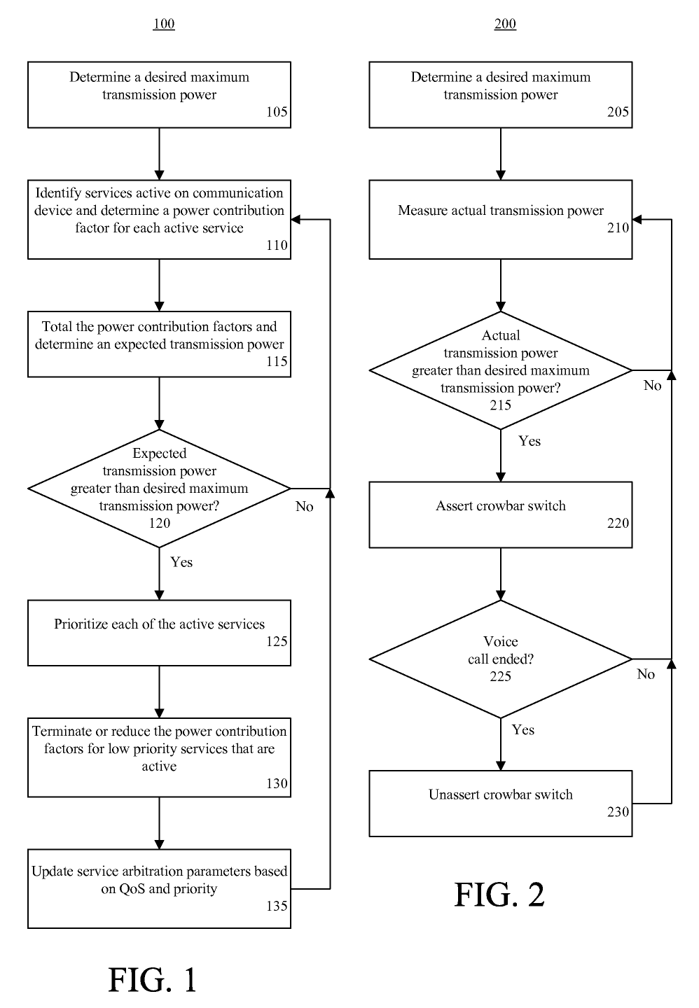

FIG. 1 is a flowchart presenting a method 100 for reducing a communication device's transmission power. As used herein, the term “transmission power” is an average value of transmit power. The average value can be determined over any suitable period, for instance 100 mS, 1 S, 10 S, 1 min., 10 min., 30 min., etc. As used herein, the term “transmit power” is a value of the energy used to transmit a unit of data. The unit of data can include a single bit or a plurality of bits, although the unit should be short enough for a plurality of units to be averaged when determining the transmission power over a suitable period.

Beginning at step 105, a desired maximum transmission power for a communication device can be determined. The desired maximum transmission power can be determined based on any desired characteristics or parameters of the communication device, or any desired characteristics or parameters of systems, objects or entities affected by the communication device's transmissions. Further, determination of the desired maximum transmission power can be performed periodically, or the process can continually monitor the communication device to update the value of the desired maximum transmission power each time a change is detected in the communication device.

For example, the desired transmission power for the communication device can be determined based on a maximum desired temperature for one or more components of the communication device. The temperature of such components generally can be estimated by determining a temperature rise attributed to power losses in the communication device, including losses due to operation of a transceiver, and adding the temperature rise to an ambient temperature of the environment in which the communication device is operating. If the communication device is operated in a low temperature environment, a much greater temperature rise can be tolerated as opposed to operation in a high temperature environment.

By way of example, if the desired maximum temperature for a component, such as a shell of the communication device, is 45° C. and the ambient temperature is 15° C., a temperature rise of 30° C. can be allowed while still preventing the component from exceeding the desired maximum temperature. On the other hand, if the ambient temperature is 35° C., only a 10° C. temperature rise would be allowed. Thus, the desired transmission power for the communication device may vary depending on the circumstances in which the communication device is used, and can change as such circumstances change. Notwithstanding, the temperature of the communication device components typically will not change suddenly with a sudden change of ambient temperature. Accordingly, the temperature of the components can be monitored and transmission power adjustments can be implemented after one or more measured temperatures approach the desired maximum temperature.

Moreover, in addition to, or in lieu of, maximum operating temperature, other parameters can be used to determine the desired transmission power for the communication device. For example, the desired transmission power can be determined based on the level of charge left in the communication device's battery. In another arrangement, effects of RF energy transmitted by the communication device can be considered. For instance, a level of interaction with other electrical systems (i.e. electromagnetic interference), objects or entities can be considered. Such interaction is usually inversely related to the distance between the communication device and such systems, objects or entities. Accordingly, such distances also can be considered when determining the maximum transmission power.

Proceeding to step 110, services active on the communication device can be identified and a power contribution factor for each of the identified services can be determined. To determine a power contribution factor for a particular service, the bit rate of the data stream for that service can be multiplied by the energy per bit of the data stream. The energy per bit can vary depending on the modulation used to modulate the data stream and the transmit power requested by a network with which the communication device communicates. For example, a base transceiver station with which the communication device is communicating can specify the transmit power that is to be used to transmit each bit.

Further, external devices to which the communication device is communicatively linked and which generate RF energy can be identified. Such objects also may have a level of interaction with other systems, objects or entities. Accordingly, the power contribution factor of such devices also can be determined.

At step 115, the power contribution factors for the services active on the communication device can be summed, or totaled, and an expected transmission power can be determined. In an arrangement in which external devices are used, the power contribution factor of such devices can be added to the active service power contribution factors to determine the expected transmission power.

Referring to decision box 120, if the expected transmission power is not greater than the desired maximum transmission power, the process can return to step 110 or, alternatively, step 105 and the process can continue. If, however, the expected transmission power is greater than the desired maximum transmission power, the process can proceed to step 125 and each of the active services can be prioritized. The service prioritization can be performed in any suitable manner. For example, in an arrangement in which the active services are assigned to quality of service (QoS) classes, the active services can be prioritized based on their QoS classes. In another arrangement, each service available on the communication device can be assigned a priority level. In general, services supporting voice calls can be given high priority.

Proceeding to step 130, one or more of the active services having the lowest priority (or priorities) can be terminated and/or power contribution factors for such services can be reduced. In one arrangement, to reduce the power contribution factor of a particular service, the bit rate of its data stream can be reduced. In another arrangement, the duty cycle of the data stream can be reduced. In yet another arrangement, the transmit energy for each bit can be reduced. It should be noted, however, that reducing the transmit energy too much may result in an increase in data loss during transmission. If the data loss exceeds an acceptable value, it may be beneficial to increase the transmit energy per bit and lower the bit rate, or terminate the active service and automatically reinitiate the service at a later time.

At step 135, service arbitration parameters based on QoS (if applicable) and priority can be updated, for instance to activate and/or document changes to the data streams. The process then can return to step 110 or, alternatively, step 105 and the process can continue.

FIG. 2 is a flowchart presenting another method 200 for reducing a communication device's transmission power. Beginning at step 205, a desired maximum transmission power for the communication device can be determined, as previously discussed. At step 210, the actual transmission power can be measured. For example, the transmission power of the communication device's transceiver can be measured. In an arrangement in which the desired maximum transmission power includes the total transmission power of the communication device and associated accessories, the transmission power of accessory transceivers also can be measured. The values of transmission power obtained from such measurements can be added to the value of transmission power measured for the communication device's transceiver.

Referring to decision box 215, if the actual transmission power (e.g. the transmission power measured for the communication device and, if applicable, accessories) is not greater than the desired maximum transmission power, the process can return to step 210. Alternatively, if the desired maximum transmission power may vary, the process can return to step 205. If, however, the actual transmission power does exceed the desired maximum power, the process can proceed to step 220 and a crowbar switch can be asserted. As used herein, the term “crowbar switch” is hardware and/or an application that, when asserted, automatically disables non-critical services that utilize a communication device's transceiver. In one aspect of the invention, the crowbar switch can be implemented exclusively with hardware, thereby making the crowbar switch less susceptible to software errors. For example, the crowbar switch can be implemented as a thermal fuse or circuit breaker. Advantageously, a circuit breaker can automatically close after the condition triggering its assertion has passed. For instance, the circuit breaker can close after a temperature being monitored has receded to an acceptable range.

In one arrangement, the crowbar switch can be configured to deactivate all non-critical services, such as those having low priority levels. In another arrangement, mid priority level services also can be deactivated. In yet another arrangement, the crowbar switch can deactivate services, beginning with the lowest priority services, until the actual transmission power no longer exceeds the desired maximum transmission power.

Proceeding to decision box 225, if the service supporting a voice call is still active, the process can return back to step 210 or, alternatively, step 205. If, however, the voice call ends, the process can proceed to step 230 and the crowbar switch can be unasserted and services which were previously deactivated then can be reactivated. The process then can return to step 210 or step 205.

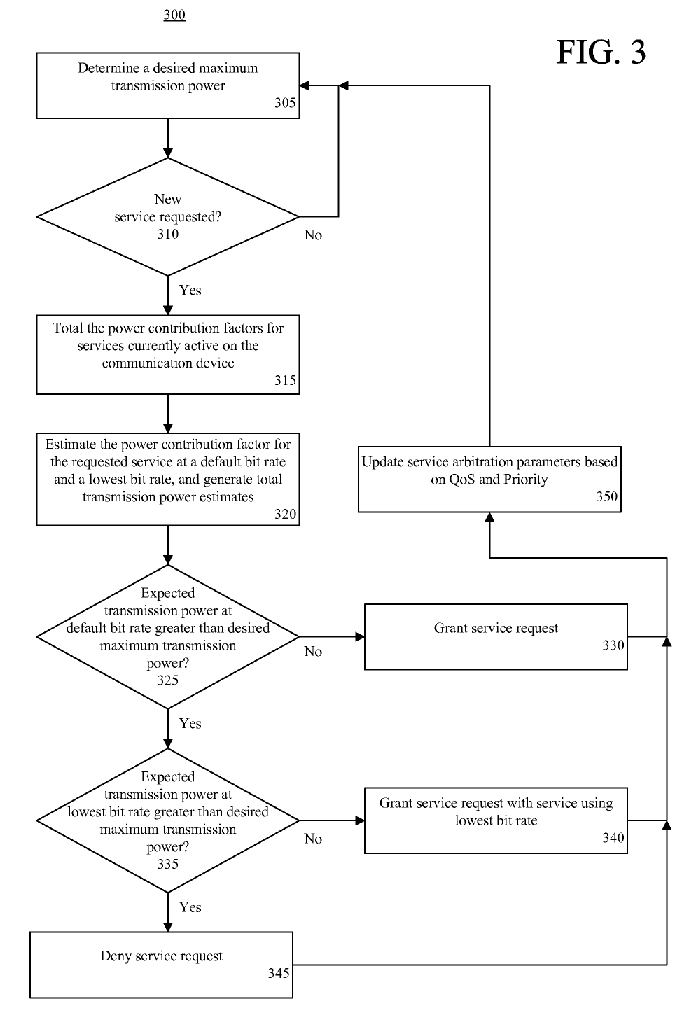

FIG. 3 is a flowchart presenting a method 300 for determining whether to grant a service request, which is useful for understanding the present invention. Beginning at step 305, a desired maximum transmission power for the communication device can be determined. Referring to decision box 310, while a new service is not requested, the process can return to step 305 and the desired maximum transmission can again be determined. As noted, determination of the desired maximum transmission power can be performed periodically, or the process can continually monitor the communication device to update the value of the desired maximum transmission power each time a change is detected in the communication device.

If a new service is requested, the process can proceed to step 315 and the power contribution for services currently active on the communication device can be determined and totaled (e.g. summed together) to generate a current transmission power. Continuing to step 320, the power contribution factor for the requested service can be estimated and added to the current transmission power to generate an expected total transmission power that includes the requested service. Such estimation can be based on, for example, an estimated bit rate of the data stream that will be generated for the requested service.

In one arrangement, a default bit rate can be used to determine the estimated power contribution factor. In another arrangement, the lowest bit rate that is suitable can be used for the estimation. In yet another arrangement, estimations of the power contribution factor can be performed using both the default bit rate and the lowest bit rate, and two total transmission power estimates can be generated. Of course, any number of such estimations can be performed for different bit rates of the requested service and the invention is not limited in this regard.

Referring to decision box 325, if the expected transmission power does not exceed the desired maximum transmission power when the requested service is implemented at the default bit rate, at step 330 the service request can be granted. If, however, the expected transmission power does exceed the desired maximum transmission power when the requested service is implemented at the default bit rate, the process can proceed to decision box 335.

Referring to decision box 335, if the expected transmission power does not exceed the desired maximum transmission power when the requested service is implemented at the lowest bit rate, at step 340 the service request can be granted with the service using the lowest bit rate. If, however, the expected transmission power still exceeds the desired maximum transmission power when the requested service is implemented at the lowest bit rate, the process can proceed to step 345 and the service request can be denied. Proceeding to step 350, the service arbitration parameters can be updated based on the QoS and priority.

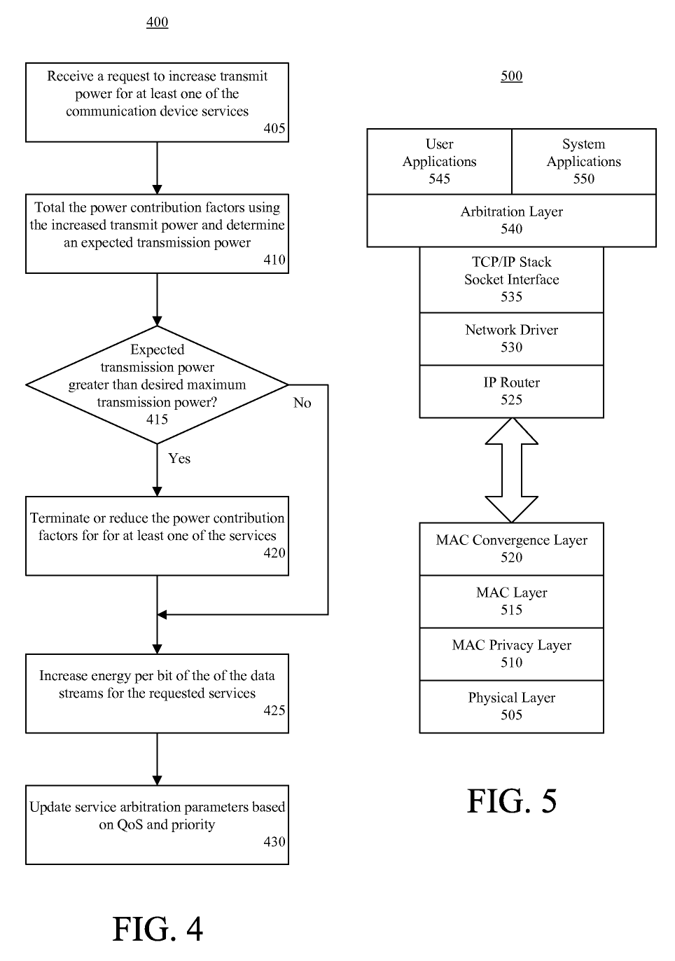

FIG. 4 is a flowchart presenting a method 400 for increasing instantaneous transmit power while not exceeding a total desired transmission power. Beginning at step 405, a request can be received to increase transmit power for one or more of the communication device services. For example, the request can be generated by a network node, such as a base transceiver station, with which the communication device has established a communication session to support a service, for instance voice communications or Internet access.

At step 410, the power contribution factors for all active services on the communication device can be totaled, or summed, to determine an expected transmission power. The requested transmit power and current bit rates can be used to compute the expected transmission power.

Referring to decision box 415, if the expected transmission power is greater than the desired maximum transmission power, the process can proceed to step 420 and power contribution factors for one or more active services can be reduced or terminated. For example, the power contribution factors for the lowest priority services can be reduced or terminated, as previously described. In another arrangement, the power contribution factor that is reduced can be the power contribution factor for the service to which the request was directed. For example, if the network node requested increased transmit power for a service supporting an Internet communications session, the bit rate of the data stream for the Internet communication session can be reduced.

Continuing to step 425, the energy per bit of the data stream for the requested service can be increased. In other words, the instantaneous transmit energy for each bit transmitted can be increased. Notably, because the bit rate of the data stream has been decreased, the total transmission power of the data stream will be less than it would have been had the bit rate not been decreased.

Referring again to decision box 415, if the expected transmission power will not exceed the desired maximum transmission power when the increased transmit power is implemented, the process can skip step 420 and proceed directly to step 425, in which case the instantaneous transmit energy for each bit can be increased without decreasing a data stream bit rate. Proceeding to step 430, the service arbitration parameters based on QoS and priority can be updated.

FIG. 5 depicts a protocol stack 500 comprising a plurality of protocol layers that are useful for understanding the present invention. The protocol stack 500 represents protocol layers that can be implemented on a communication device implementing the processes described herein. The protocol stack 500 can include, for instance, a plurality of protocol layers that are implemented by a modem within the communication device's transceiver. Such layers can include a physical layer 505, a media access control (MAC) privacy layer 510, a MAC layer 515 and a MAC convergence layer 520, each of which are well known to the skilled artisan. The protocol stack 500 also can include a plurality of protocol layers implemented by networking services. Such layers can include an internet protocol (IP) router 525, a network driver 530, and a transmission control protocol over IP (TCP/IP) stack socket interface 535. Again such layers are well known to the skilled artisan.

The protocol stack 500 further can include an arbitration layer 540. The arbitration layer 540 can arbitrate usage of the protocol layers 505-535 by services associated with user applications 545 and system applications 550. For example, determination of desired maximum transmission power, monitoring of actual transmission power, and prioritization of services can be performed at the arbitration layer 500. Further, decisions whether to terminate specific services or to reduce their power contribution factors, and decisions whether to grant service requests also can be performed at the arbitration layer 540. Still, a number of other functions can be performed at the arbitration layer 540 and the invention is not limited in this regard.

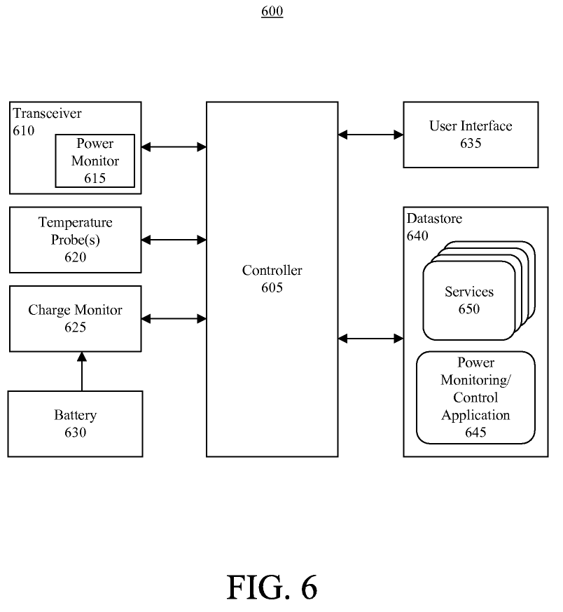

FIG. 6 depicts a block diagram of a communication device 600 that is useful for understanding the present invention. The communication device 600 can be a mobile communication device, such as a mobile computer, a personal digital assistant (PDA) or a mobile telephone, or any other electronic apparatus that can wirelessly communicate. The communication device 600 can include a controller 605. The controller 605 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The communication device 600 also can include a transceiver 610 that is used by the communication device 600 to communicate with a communications network or other wireless communication devices. The transceiver 610 can communicate data via IEEE 802 wireless communications, including 802.11 and 802.16 (WiMax), WPA, WPA2, GSM, TDMA, CDMA, WCDMA, direct wireless communication, TCP/IP, or any other suitable form of wireless communications. Further, the transceiver 610 can include a power monitor 615 that may be used to measure the transmission power output by the transceiver 610. Power monitors are known to those skilled in the art.

In operation, the transceiver 610 can receive control signals from the controller 605 which indicate the transmit power to apply for transmitting units of data contained in the various data streams, indicate the modulation scheme(s) to apply while transmitting the data streams, indicate the data rate(s) at which to transmit the data streams, and/or indicate any other parameters that can be applied by the transceiver 610. Similarly, the transceiver 610 can communicate signals to the controller 605 which indicate various transmission parameters that may be measured, for instance actual transmission power measured by the power monitor 615.

The communication device also can include one or more temperature probes 620. The temperature probes 620 can monitor the temperature of one or more components of the communication device. For example, the temperature probes 620 can monitor the temperature of the shell of the communication device, components of the transceiver 610, or any other device components that may vary in temperature. Further, one or more of the temperature probes 620 also may monitor an ambient temperature (i.e. temperature of the environment where the communication device is operating). Temperature measurements from the temperature probes 620 can be communicated to the controller 605 as signals to be processed by one or more applications instantiated on the controller 605.

A charge monitor 625 also can be included in the communication device 600. The charge monitor can monitor a charge of the communication device's battery 630, and communicate signals representing the level of charge remaining on the battery to the controller 605. Such signals also can be processed by one or more applications instantiated on the controller 605.

A user interface 635 can be provided on the communication device 600. The user interface 635 can include a keypad, buttons 230, a display 220, input and output audio transducers, biometric sensors, or any other devices which facilitate user interaction with the communication device 600. In an arrangement in which the communication device can be communicatively linked to external accessories, such as headsets or music systems, the user interface 635 also can include one or more suitable user interface adapters (not shown). Examples of such adapters can include a universal serial bus (USB) adapter, a wired user interface, a wireless user interface, such as a Bluetooth adapter or a ZigBee adapter, or any other suitable user interface adapters.

The communication device 600 also can include a datastore 640. The datastore 640 can include one or more storage devices, each of which can include a magnetic storage medium, an electronic storage medium, an optical storage medium, a magneto-optical storage medium, and/or any other storage medium suitable for storing digital information. In one arrangement, the datastore 640 can be integrated into the controller 605.

A power monitoring/control application 645 can be contained on the datastore 640. The power monitoring/control application 645 can be executed by the controller 605 to implement the methods and processes described herein. For example, the power monitoring/control application 645 can determine the desired maximum transmission power, receive signals from the transceiver's power monitor 615 to monitor actual transmission power, receive signals from the charge monitor 625 to monitor battery charge level, and prioritize services 650. Further, decisions whether to terminate specific services 650, or to reduce their power contribution factors, and decisions whether to grant service requests also can be performed by the power monitoring/control application 645. As noted, one or more of such functions can be performed at the arbitration layer.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for limiting transmission power of a communication device, comprising:
determining a desired maximum transmission power;
determining a plurality of power contribution factors, each of the power contribution factors associated with a respective service active on the communication device;
determining an expected transmission power based on, at least in part, a sum of the power contribution factors; and
responsive to the expected transmission power exceeding the desired maximum transmission power, selectively reducing or terminating the power contribution for at least one of the services active on the communication device.

2. The method of claim 1, wherein selectively reducing the power contribution comprises reducing a bit rate of a service data stream for the at least one service.

3. The method of claim 1, wherein selectively reducing the power contribution comprises reducing a duty cycle of a service data stream for the at least one service.

4. The method of claim 1, wherein selectively terminating the power contribution comprises terminating the at least one service.

5. The method of claim 1, further comprising:
prioritizing each of the services active on the communication device;
wherein selectively reducing the power contribution comprises reducing the power contribution for at least one of the services having a low priority.

6. The method of claim 5, wherein prioritizing the services comprises determining a quality of service class associated with each of the services.

7. The method of claim 1, wherein determining the power contribution factor comprises, for each of the active services, multiplying a bit rate of the service data stream by an energy per bit of the service data stream.

8. The method of claim 7, further comprising:
receiving a request for an increase in instantaneous transmit power of the service data stream for at least a first of the active services;
reducing the bit rate of the service data stream for at least one of the active services; and
increasing the energy per bit of the service data stream for the first active service.

9. The method of claim 1, further comprising:
responsive to detecting an actual transmission power exceeding the desired maximum transmission power, deactivating at least one of the services active on the communication device.

10. The method of claim 1, further comprising:
determining an external power contribution factor for at least one external device;
wherein determining the expected transmission power is further based, at least in part, on the external power contribution factor.

11. A machine readable storage, having stored thereon a computer program having a plurality of code sections comprising:
code for determining a desired maximum transmission power;
code for determining a plurality of power contribution factors, each of the power contribution factors associated with a respective service active on the communication device;
code for determining an expected transmission power based on, at least in part, a sum of the power contribution factors; and
code for selectively reducing or terminating the power contribution for at least one of the services active on the communication device in response to the expected transmission power exceeding the desired maximum transmission power.

12. A communication device, comprising:
a transceiver; and
a controller that determines a desired maximum transmission power, determines a plurality of power contribution factors, each of the power contribution factors associated with a respective service active on the communication device, determines an expected transmission power based on, at least in part, a sum of the power contribution factors, and selectively reduces or terminates the power contribution for at least one of the services active on the communication device in response to the expected transmission power exceeding the desired maximum transmission power.

13. The communication device of claim 12, wherein the controller selectively reduces the power contribution by signaling the transceiver to reduce a bit rate of a service data stream for the at least one service.

14. The communication device of claim 12, wherein the controller selectively reduces the power contribution by signaling the transceiver to reduce a duty cycle of a service data stream for the at least one service.

15. The communication device of claim 12, wherein the controller selectively terminates the power contribution by terminating the at least one service.

16. The communication device of claim 12, wherein:
the controller prioritizes each of the services active on the communication device; and
the controller selectively reduces the power contribution by reducing the power contribution for at least one of the services having a low priority.

17. The communication device of claim 16, wherein the controller prioritizes the services by determining a quality of service class associated with each of the services.

18. The communication device of claim 12, wherein the controller determines the power contribution factor by, for each of the active services, multiplying a bit rate of the service data stream by an energy per bit of the service data stream.

19. The communication device of claim 18, wherein:
the controller receives a request for an increase in instantaneous transmit power of the service data stream for at least a first of the active services;
the controller signals the transceiver to reduce the bit rate of the service data stream for at least one of the active services; and
the controller signals the transceiver to increase the energy per bit of the service data stream for the first active service.

20. The communication device of claim 12, wherein the controller deactivates at least one of the services active on the communication device in response to detecting an actual transmission power exceeding the desired maximum transmission power.
